(19) United States
(12) Patent Application Publication
(10) Pub. No.: US 2005/0035498 A1
(43) Pub. Date: Feb. 17, 2005

(54) Methods of making a negative hearing aid mold

(76) Inventor: Randal Alan Stevens, Hanover, MN (US)

Correspondence Address: Alan D. Kamrath;Rider Bennett, LLP, Suite 2000, 333 South Seventh Street, Minneapolis, MN, 55402, US

(21) Appl. No.: 10/640,553

(22) Filed: Aug. 13, 2003

(51) Int. Cl. B29C 35/08; B29C 41/02; B29C 33/40

(52) U.S. Cl. 264/401; 264/227; 264/40.1; 264/497; 264/308

(57) ABSTRACT

A negative hearing aid mold (10) is made by first processing auditory canal (21) dimension measurement data representing internal dimensions of an auditory canal (21) to generate outside auditory canal dimension data that represents outside dimensions of the auditory canal (21). An impression (22) of the auditory canal (21) is taken from a wearer. The outside auditory canal dimension data is processed to generate outside mold data. A laser (26) is used to measure the dimensions of the impression (22). A negative hearing aid mold (10) is created from the outside mold data using a rapid prototyping such as stereo lithography machine (36). The negative hearing aid mold (10) has an inside surface representing the outside dimensions of the auditory canal (21) from the outside mold data. The negative hearing aid mold (10) is suitable for receipt of a soft solid such as silicone. The negative hearing aid mold is (10) used to make a soft solid hearing aid (16).

### FIELD OF THE INVENTION

The present invention relates to methods to make a negative hearing aid mold and more particularly to methods to use rapid prototyping such as stereo lithography, fused deposition modeling, and laser sintering to make a negative hearing aid mold.

### BACKGROUND OF THE INVENTION

Hearing aids have been made utilizing various techniques including using vacuum forming to create a negative mold for the hearing aid and the creation of the hard solid hearing aid bodies directly from stereo lithography techniques.

Many hearing aids are designed for insertion in the auditory canal which includes the portion of the ear defined by parts of the pinna and the external ear canal. The external ear canal includes the cartilaginous portion and the bony portion.

In the vacuum forming process, an impression of the auditory canal is used to create a hard cast which is then used to create the negative mold through vacuum lamination, e.g. the impression by itself cannot be used directly. The negative mold is then filled with silicon or other suitable soft material. Before filing with silicone, the hearing electronics and transducers are installed. This construction technique results in a soft solid hearing aid.

Vacuum forming has the distinct draw back that auditory canal shapes and dimensions are not faithfully reproduced. The vacuum forming techniques do not have the ability to faithfully reproduce the topology of the auditory canal due to surface undulations and curves that exceed the limits of this technology. This situation creates a potentially uncomfortable or irritating hearing aid because of misfit and audio feedback. These discomforts arise directly from the nonconforming aspects of the resulting hearing aid. The nonconforming aspects of the resulting hearing aid are a direct result of a low fidelity mold.

A misfit hearing aid is uncomfortable due to the tender nature of the pinna and external auditory canal. A nonconforming hearing aid creates an auditory feedback pathway from the canal tip region, through the space between the hearing aid body and microphone input. Audio feedback directly interferes with the functioning of the hearing aid and is uncomfortable.

During the creation of the hard solid hearing aid bodies directly from stereo lithography techniques, a shell hearing aid body is directly created using rapid prototyping such as stereo lithography. Directly creating the shell hearing aid body does not utilize a negative mold and thus cannot be used to create soft solid hearing aids.

Therefore, there is a need for a novel method of creating a high fidelity negative hearing aid mold that is useful for the creation of a soft solid hearing aid.

Therefore, there is a need for such a novel method of creating a negative hearing aid mold that is useful for the creation of a soft solid hearing aid using rapid prototyping such as stereo lithography, fused deposition modeling, and laser sintering.

### SUMMARY

The present invention solves these needs and other problems in the field of negative hearing aid mold creation by first processing auditory canal dimension measurement data representing dimensions of the auditory canal to generate outside auditory canal dimension data that represents outside dimensions of the auditory canal. Next, the outside auditory canal dimension data is processed to generate outside mold data. Then, a negative hearing aid mold is created from the outside mold data using rapid prototyping such as stereo lithography, fused deposition modeling, Digital light processing, such as Perfactory TM DLP technology, and laser sintering, with the negative hearing aid mold having an inside surface representing the outside dimensions of the auditory canal from the outside mold data, with the negative hearing aid mold suitable for receipt of a soft solid during the formation of a soft solid hearing aid.

In other aspects of the present invention, the methods provide that the soft solid is silicone or any other suitable materials available to create the soft solid.

In other aspects of the present invention, the methods provide that the auditory canal dimension measurement data representing internal dimensions of an auditory canal includes measuring the outside dimensions of an impression of an auditory canal to generate the outside auditory canal dimension data.

In other aspects of the present invention, the methods provide measuring the outside dimensions of the impression of an auditory canal by measuring the outside dimensions of the impression of an auditory canal with a laser to generate laser measured auditory canal data and then generating point cloud/STL data from the laser measured auditory canal data.

In other aspects of the present invention, the methods process the outside auditory canal dimension data to generate the outside mold data in the form of point cloud/STL data.

In other aspects of the present invention, the methods further include generating stereo lithography data from the point cloud/STL data.

In other aspects of the present invention, the methods analyze the impression to generate auditory canal point cloud/STL data using a laser to measure a plurality of surface positions on the impression to generate the auditory canal point cloud/STL data.

In other aspects of the present invention, the methods create a negative hearing aid mold from the outside mold data using stereo lithographic techniques. The negative hearing aid mold is suitable for use as an outside mold for the construction of a hearing aid.

In other aspects of the invention, a soft solid negative hearing aid mold is created from the outside mold data using stereo lithographic techniques, with the soft solid negative hearing aid mold suitable for use as an outside mold for the construction of a soft solid hearing aid.

In other aspects of the present invention, the methods create a negative hearing aid mold from the outside mold data using rapid prototyping such as stereo lithography, fused deposition modeling, Digital light processing, and laser sintering with the addition of making an hearing aid mold from the outside mold data using rapid prototyping such as stereo lithography, fused deposition modeling, Digital light processing, and laser sintering.

In other aspects of the present invention, the methods create a negative hearing aid mold from the outside mold data using rapid prototyping such as stereo lithography, fused deposition modeling, digital light processing, and laser sintering with the addition of making an epoxy based hearing aid mold from the outside mold data using rapid prototyping such as stereo lithography, fused deposition modeling, Digital light processing, and laser sintering with SLA Epoxy Resin Si, medical grade acrylonitrile butadiene styrene (ABS), or with powdered nylon.

In other aspects of the present invention, the methods further include mounting the negative hearing aid mold on a faceplate and placing a soft solid in the negative hearing aid mold.

In other aspects of the present invention, the methods place a soft solid in the form of silicone in the negative hearing aid mold.

In other aspects of the present invention, the methods include installing hearing aid transducers and electronics in the negative hearing aid mold.

In other aspects of the present invention, the methods process, with a computer processor, the auditory canal dimension measurement data representing dimensions of an auditory canal to generate outside auditory canal dimension data that represents outside dimensions of the auditory canal.

In other aspects of the invention, the methods process, with a computer processor, the outside auditory canal dimension data to generate outside mold data.

In other aspects of the invention, the methods further comprising measuring auditory canal dimension measurement data representing dimensions of an auditory canal directly from the auditory canal to generate outside auditory canal dimension data that represents outside dimensions of the auditory canal.

In other aspects of the invention, the methods provide creating a negative hearing aid mold from the outside mold data using rapid prototyping further comprises creating the negative hearing aid mold from the outside mold data using rapid prototyping such as stereo lithography.

In other aspects of the invention, the methods provide creating a negative hearing aid mold from the outside mold data using rapid prototyping further comprises creating the negative hearing aid mold from the outside mold data using fused deposition modeling.

In other aspects of the invention, the methods provide creating a negative hearing aid mold from the outside mold data using rapid prototyping further comprises creating the negative hearing aid mold from the outside mold data using laser sintering.

In other aspects of the invention the methods provide for making a negative hearing aid mold comprising the steps of processing laser measured auditory canal dimension measurement data representing dimensions of an auditory canal to generate outside auditory canal dimension data that represents outside dimensions of the auditory canal, with the laser measured auditory canal dimension measurement data obtained with a laser measurement system; processing the outside auditory canal dimension data to generate outside mold data; and creating a negative hearing aid mold from the outside mold data using rapid prototyping, with the negative hearing aid mold having an inside surface, with the inside surface representing the outside dimensions of the auditory canal from the outside mold data, with the negative hearing aid mold suitable for receipt of a soft solid.

These and further objects and advantages of the present invention will become clearer in light of the following detailed description of an illustrative embodiment of this invention described in connection with the drawings.

### DESCRIPTION OF THE DRAWINGS

The illustrative embodiment may best be described by reference to the accompanying drawings where:

FIG. 1 shows a negative hearing aid mold created following the preferred methods according to the teachings of the present invention.

FIG. 2 diagrammatically shows preferred methods according to the teachings of the present invention.

FIG. 3 shows an impression taken from the auditory canal.

FIG. 4 shows a schematic diagram of a laser measuring system measuring the impression following the preferred methods according to the teachings of the present invention.

FIG. 5 shows point cloud/STL data representing the impression following the preferred methods according to the teachings of the present invention.

FIG. 6 shows the point cloud/STL data representing the impression after being processed into outside auditory canal data for use in making a stereo lithography, fused deposition modeling, and laser sintering based negative hearing aid mold following the preferred methods according to the teachings of the present invention.

FIG. 7 shows the negative hearing aid mold being created in a stereo lithography machine following the preferred methods according to the teachings of the present invention.

FIG. 8 shows the negative hearing aid mold created following the preferred methods according to the teachings of the present invention being filled with a soft solid and hearing aid electronics to create a soft solid hearing aid.

All figures are drawn for ease of explanation of the basic teachings of the present invention only; the extensions of the figures with respect to number, position, relationship, and dimensions of the parts to form the preferred embodiment will be explained or will be within the skill of the art after the following description has been read and understood. Further, the exact dimensions and dimensional proportions to conform to specific force, weight, strength, and similar requirements will likewise be within the skill of the art after the following description has been read and understood.

Where used in the various figures of the drawings, the same numerals designate the same or similar parts. Furthermore, when the terms “side,” “end,” “bottom,” “first,” “second,” “laterally,” “longitudinally,” “row,” “column,” and similar terms are used herein, it should be understood that these terms have reference only to the structure shown in the drawings as it would appear to a person viewing the drawings and are utilized only to facilitate describing the illustrative embodiment.

### DESCRIPTION OF THE PREFERRED EMBODIMENTS

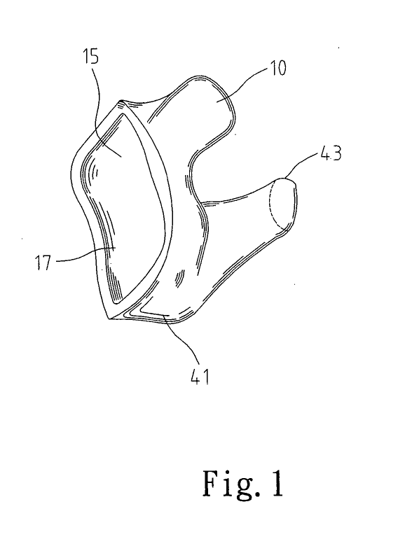

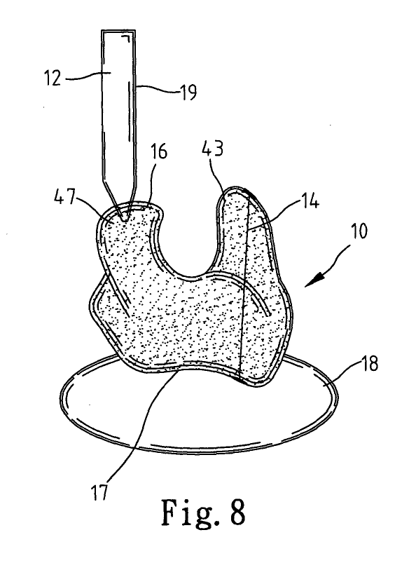

A negative hearing aid mold produced according to the preferred teachings of the present invention is shown in the drawings and generally designated 10. FIG. 1 shows a negative hearing aid mold 10 created following the preferred methods according to the teachings of the present invention. The negative hearing aid mold 10 is used as a mold to create a soft solid hearing aid 16; the hearing aid 16 is shown being created in FIG. 8.

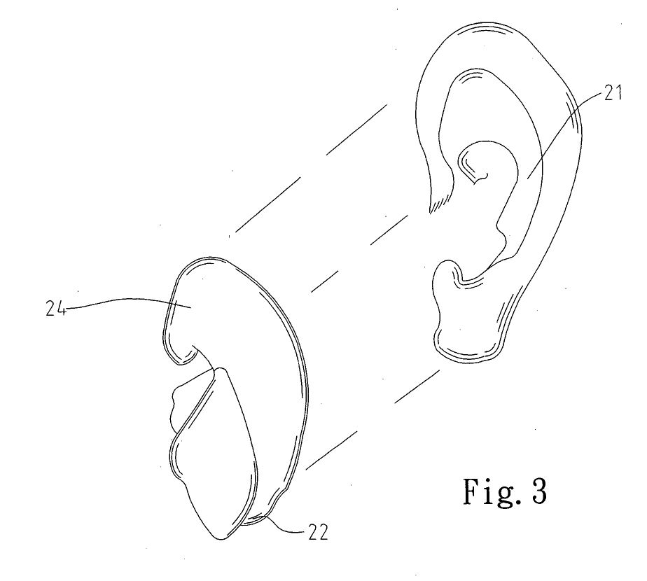

An inside surface 15 of the negative hearing aid mold 10 conforms to an outside surface 24 of an impression 22 taken of an auditory canal 21. The impression 22 is shown in FIG. 3. The negative hearing aid mold 10 according to the teachings of the present invention provides a negative impression of the auditory canal 21, so that when the negative hearing aid mold 10 is filled with a soft solid 12 from a soft solid applicator 19, the soft solid hearing aid 16 may be produced that fits well in the auditory canal 21.

When the soft solid hearing aid 16 is constructed, a bowl end 17 of the negative hearing aid mold 10 is mounted on a faceplate 18. In one embodiment according to the preferred teachings of the present invention, a helix area 47 of the negative hearing aid mold 10 maybe used to insert the soft solid 12 from a soft solid applicator 19 to create the body of the hearing aid 16. Those skilled in the art will recognize that other areas of the hearing aid mold 10, other than the helix area 47, can be used for the insertion of the soft solid 12, such as in smaller hearing aid molds having various shapes. The faceplate 18 is shown in FIG. 8. The bowl end 17 is open to allow insertion of hearing aid electronics and transducers 14, also shown in FIG. 8. The negative hearing aid mold 10 also has an outside surface 41 and a canal tip portion 43.

The negative hearing aid mold 10 is designed to create the hearing aid 16 that fits in the auditory canal 21 but other types of negative hearing aid molds 10 may be created with the preferred methods of the present invention and are within the spirit and scope of the invention. Undercuts and undulations in the topology of the auditory canal 21 make it difficult for prior art methods to produce a mold that conforms. The construction methods for the negative hearing aid mold 10 according to the preferred teachings of the invention are not affected by such undercuts and undulations. A nonconforming mold may create a hearing aid 16 that is uncomfortable or impossible to wear.

The hearing aid 16 that can be constructed with the negative hearing aid mold 10 according to the teachings of the present invention has a high degree of conformance to the impression 22. Thus, the hearing aid 16 is comfortable to wear because it does not unduly impinge on the auditory canal 21. Since the hearing aid 16 fits well in the auditory canal 21, no direct air pathways are created between the receiver and the microphone of the hearing aid 16. This conforming fit reduces or eliminates audio pathways available to create audio feedback. Therefore, a much better performing hearing aid 16 can be created with the negative hearing aid mold 10 produced according to the teachings of the present invention.

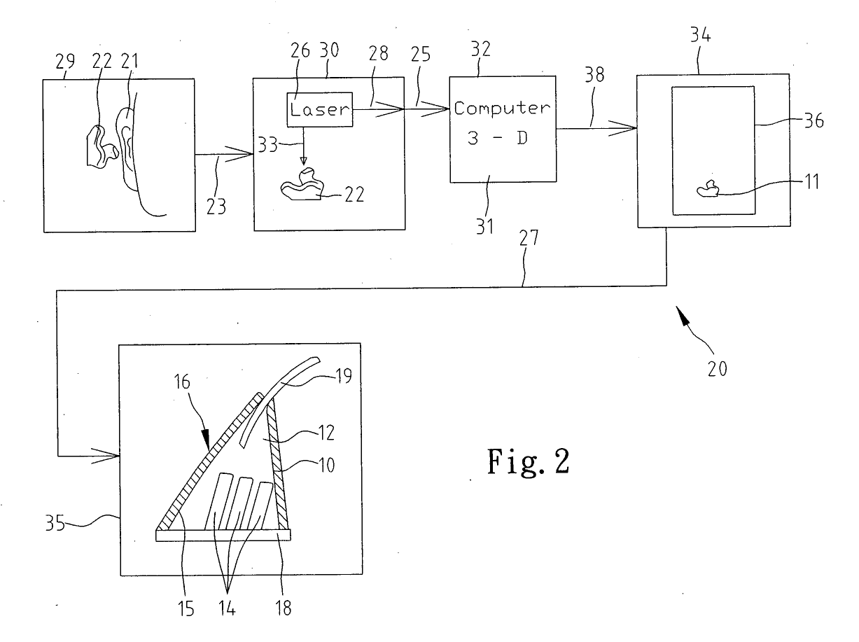

FIG. 2 shows a diagram 20 diagrammatically illustrating the preferred methods of the present invention.

As diagrammatically shown by box 29 and FIG. 3, the impression 22 of the auditory canal 21 is taken. The impression 22 provides a model of the auditory canal 21 and is obtained with conventional means. Those skilled in the art will recognize that other methods of obtaining the impression 22 of the auditory canal 21 are within the spirit and scope of the invention such as direct inner ear scanning using optical or MRI (magnetic resonance imaging) with direct transmission of measurement data of the auditory canal 21 for mold production. Arrow 23 indicates that the impression 22 is made available to a topology characterization device, such as a laser topology system 26.

As diagrammatically shown by box 30 and in a preferred form, dimensions are taken from the outside surface 24 of the impression 22. In a most preferred form, a laser topology system 26 is utilized to measure the outside dimensions of the impression 22 with a laser beam 33. Those skilled in the art will appreciate that other technologies can be used to measure the outside dimensions of the impression such as white light and digital imagining. The impression 22 is mounted in the laser topology system 26 in a way that permits reliable and consistent measurement. For some systems, the impression 22 is mounted on a three-pronged mount 44 in an orientation that facilitates an analysis methodology, conventionally known as a path plan. For example, the canal faces the laser and the tragus portion of the impression faces a consistent way from impression to impression. Other laser topology systems require that the impression 22 be positioned perpendicular to the mount 44. Other scanners do not require such orientations. The laser topology system 26 captures complex geometry through laser line scanning and translating of X, Y, Z data. Conformance utilizing prior methods is thus hit or miss. The present invention therefore avoids the hit and miss techniques of the prior art by producing a high fidelity negative hearing aid mold 10. The laser topology system 26 outputs the three-dimensional measurement of the outside dimensions of the impression 22 as point cloud/STL data 28. The point cloud data may be converted to a file type used for stereo lithography data also known as STL data. The laser topology system 26 analyzes the impression 22 to generate point cloud/STL data 28 from the auditory canal 21 using the laser beam 33 to measure surface positions on the outside surface 24 of the impression 22 to generate the auditory canal point cloud/STL data 28.

According to the preferred teachings of the present invention, auditory canal dimension measurement data representing dimensions of the auditory canal 21 are processed by the laser topology system 26 to generate outside auditory canal dimension data, such as the point cloud/STL data 28, that represents outside dimensions of the auditory canal 21. The outside dimension data represents the boundary of the auditory canal 21 such that, when the negative hearing aid mold 10 is used to create the hearing aid 16, the inside surface 15 of the negative hearing aid mold 10 conforms to the outside dimension of the auditory canal 21 as represented by the impression 22. Thus, the resultant hearing aid 16 will conform well to the auditory canal 21.

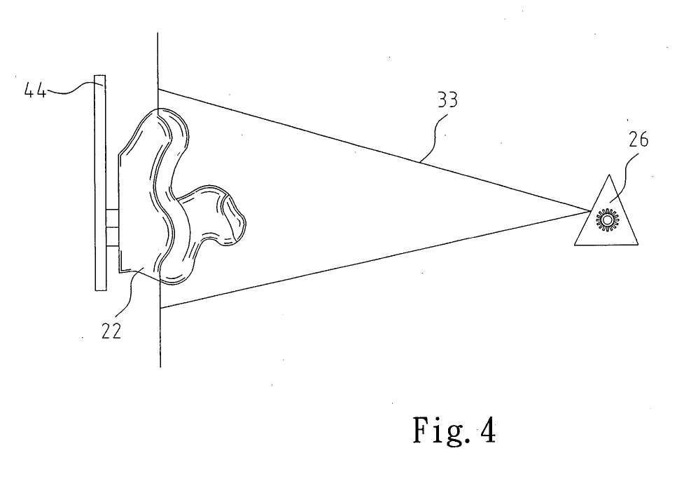

FIG. 4 shows a schematic diagram of the laser topology system 26 measuring the impression 22 with the laser beam 33. To obtain the outside dimensions 28 of the impression 22, which represent the dimensions of the auditory canal 21, the laser topology system 26 scans the impression with the laser beam 33 and detects reflected laser signals and converts this data into measurements of the outside 24 of the impression 22. Laser based measurement of the impression 22 has the advantage of providing a rapid and accurate measurement of the impression 22. The laser topology system 26 which can be utilized with the methods of the present invention is available from either Laser Design, Inc. or ThreeShape of Copenhagen, Denmark. Those skilled in the art will recognize that other methods, both automated and manual, of obtaining the dimensions of the auditory canal 21 may be used such as mechanical measurement or other laser based methods such as efforts of workers in the art to directly measure the auditory canal 21 without the need for the impression 22, without deviating from the spirit and scope of the invention. According to the preferred teachings of the present invention, the laser topology system 26 is computer processor based.

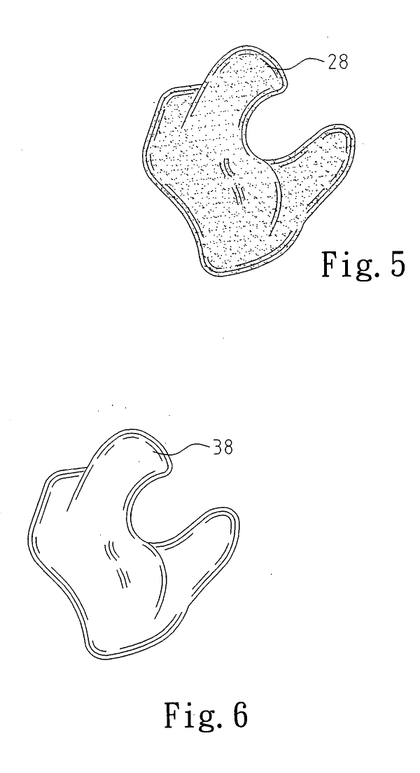

FIG. 5 shows the point cloud/STL data 28 representing the impression 22. The point cloud/STL data 28 is diagrammatically shown being provided to a computer processor 31 in FIG. 2. The point cloud/STL data 28 is the result of processing the laser measurements of the impression 22. The point cloud/STL data 28 is provided in three-dimensional format representing the spatial measurements of the impression 22 by the laser topology system 26. Arrow 25 indicates that the point cloud/STL data 28 is provided for further processing as diagrammatically shown by box 32.

The provision of the point cloud/STL data 28 could either be through a local connection or a remote connection such as the internet. Other communication methods may be used without deviating from the spirit and scope of the present invention.

Also, as diagrammatically shown by box 32, the point cloud/STL data 28 is converted to stereo lithography data such as auditory canal shell data 38 by the computer processor 31. The computer processor 31 receives the point cloud/STL data 28 from the laser topology system 26. The computer processor 31 outputs the stereo lithography data such as auditory canal shell data 38. According to the preferred teachings of the present invention, the computer processor 31 processes the outside auditory canal dimension data, such as the point cloud/STL data 28, to generate outside mold data, such as the auditory canal shell data 38.

FIG. 6 shows a graphical representation of the point cloud/STL data 28, representing the impression 22, after being processed into auditory canal shell data 38 for use in making a stereo lithography based negative hearing aid mold 10 and follow techniques used in the either the shell design software called Shell Designer from 3Shape of Copenhagen, Denmark or the software called E-Shell from RainDrop Geomagic of North Carolina, USA. The computer processor 31 utilizes detailing software from RainDrop Geomagic or 3Shape and establishes well known customer features and parameters such as shell thickness, hole dimension, engraving, and surface editing. Other data conversion techniques and customization methods that produce an auditory canal shell design from measurement of the impression 22 are within the spirit and scope of the present invention.

The provision of the auditory canal shell data 38 could either be through a local connection or a remote connection such as the Internet. Other communication methods may be used without deviating from the spirit and scope of the invention.

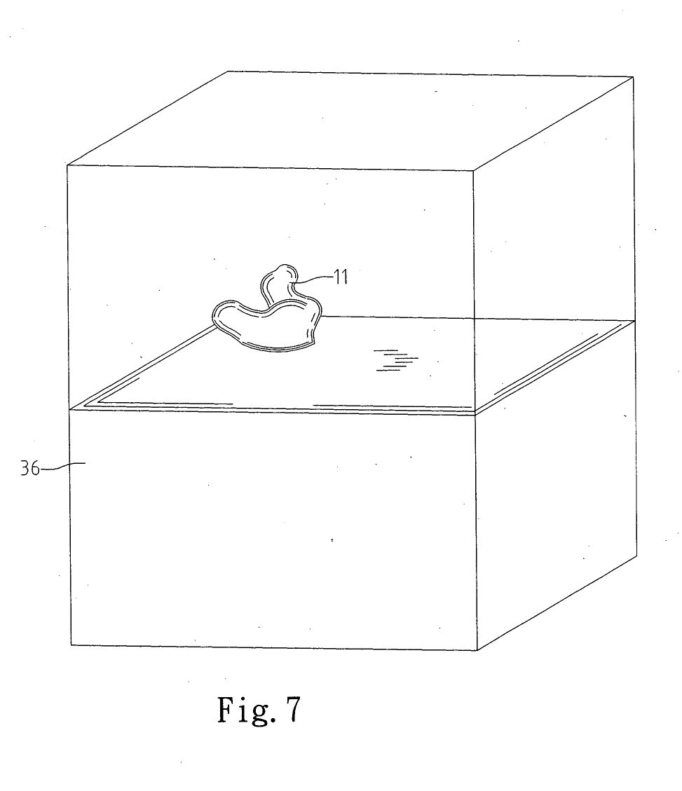

As diagrammatically shown by box 34, the negative hearing aid mold 10 is created from the auditory canal shell data 38. FIG. 7 shows a partially formed negative hearing aid mold 11 being created in a stereo lithography machine 36. Other production technologies could be used such as fused deposition modeling and laser sintering. In fused deposition modeling the article is created out of medical grade ABS acrylonitrile butadiene styrene. In laser sintering the article is made out of powdered nylon. The partially formed negative hearing aid mold 11 is made using standard stereo lithography techniques. According to the preferred teachings of the present invention, the stereo lithography machine 36 is, and, utilizes an epoxy, from 3D Systems of Valencia, Calif. known as part description: SLA Epoxy Resin Si-10. Other stereo lithographic construction materials can be used without deviating from the spirit and scope of the invention, such as any other rapid prototype material suitable for stereo lithography. The resulting negative hearing aid mold 10 functions as a form for the construction of a hearing aid 16. According to the preferred teachings of the present invention, the stereo lithography machine 36 creates the negative hearing aid mold 10 from the outside mold data, such as the auditory canal shell data 38, using rapid prototyping such as stereo lithography, fused deposition modeling, Digital light processing, and laser sintering, with the negative hearing aid mold 10 having the inside surface 15 rapid prototyping is also known as concept modeling or rapid manufacturing systems. The inside surface 15 represents the outside dimensions of the auditory canal 21 from the outside mold data, such as the auditory canal shell data 38. The negative hearing aid mold 10 is suitable for receipt of a soft solid 12 from a soft solid applicator 19. The 3D Systems makes use of Light Year software and Build Station software to create a multi part-multi slice database as is conventionally used in the stereo lithography art. More than one negative hearing aid mold 10 may be created at a time. For example, up to 120 or more negative hearing aid molds 10 may be made in a run.

As diagrammatically illustrated by box 35, the negative hearing aid mold 10 is further processed to create the hearing aid 16. FIG. 8 shows the negative hearing aid mold 10 being filled with the soft solid 12 and hearing aid electronics and transducers 14 to create the soft solid hearing aid 16. The negative hearing aid mold 10 is designed to receive the soft solid 12 and hearing aid electronics and transducers 14.

The soft solid 12 is made from silicone, as the principal material used to ultimately form the body of the hearing aid 16. Silicones are materials that exhibit physiological inertness and thermal stability. Those skilled in the art will recognize that these examples are provided by way of example and not limitation and any other hearing aid application compatible material may be used without deviating from the spirit and scope of the invention. The hearing aid electronics and transducers 14 are those well known in the art but other electronic and transducer combinations may be used that are compatible with the applied soft solid 12. The negative hearing aid mold 10 is filled with the soft solid 12 after being placed on faceplate 18, as diagrammatically illustrated by arrow 27, and after having the hearing aid electronics and transducers 14 installed, preferably by being attached to the faceplate 18 before the negative hearing aid mold 10 is placed on the faceplate 18.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. Method comprising:
processing auditory canal dimension measurement data representing dimensions of an auditory canal to generate outside auditory canal dimension data that represents outside dimensions of the auditory canal;
processing the outside auditory canal dimension data to generate outside mold data; and
creating a negative hearing aid mold from the outside mold data using rapid prototyping, with the negative hearing aid mold having an inside surface, with the inside surface representing the outside dimensions of the auditory canal from the outside mold data, with the negative hearing aid mold suitable for receipt of a soft solid.

2. The method of claim 1 with processing the auditory canal dimension measurement data representing dimensions of the auditory canal comprising measuring the outside dimensions of an impression of the auditory canal to generate the outside auditory canal dimension data.

3. The method of claim 2 with measuring the outside dimensions of the impression of an auditory canal comprising measuring the outside dimensions of the impression of the auditory canal with a laser to generate laser measured auditory canal data.

4. The method of claim 2 with measuring the outside dimensions of the impression of an auditory canal comprising:
measuring the outside dimensions of the impression of the auditory canal with a laser to generate laser measured auditory canal data; and
generating point cloud/STL data from the laser measured auditory canal data.

5. The method of claim 2 further comprising analyzing the impression to generate auditory canal point cloud/STL data using a laser to measure a plurality of surface positions on the impression to generate the auditory canal point cloud/STL data.

6. The method of claim 1 with processing the outside auditory canal dimension data to generate outside mold data comprising generating point cloud/STL data.

7. The method of claim 6 further comprising generating stereo lithography data from the point cloud/STL data.

8. The method of claim 1 with creating the negative hearing aid mold comprising creating a negative hearing aid mold from the outside mold data using stereo lithographic techniques with the negative hearing aid mold suitable for use as an outside mold for the construction of a soft solid hearing aid.

9. The method of claim 1 with creating the negative hearing aid mold comprising making an epoxy based hearing aid mold from the outside mold data using rapid prototyping such as stereo lithography.

10. The method of claim 1 with the creating the negative hearing aid mold comprising making an epoxy based hearing aid mold from the outside mold data using rapid prototyping such as stereo lithography with SLA Epoxy Resin Si-10.

11. The method of claim 1 with the creating the negative hearing aid mold comprising making an medical grade acrylonitrile butadiene styrene ABS based hearing aid mold from the outside mold data using rapid prototyping such as fused deposition modeling.

12. The method of claim 1 with the creating the negative hearing aid mold comprising making an powdered nylon hearing aid mold from the outside mold data using rapid prototyping such as laser sintering.

13. The method of claim 1 with the creating the negative hearing aid mold comprising making an powdered nylon hearing aid mold from the outside mold data using rapid prototyping such as Digital light processing.

14. The method of claim 1 with the creating the negative hearing aid mold comprising making an epoxy based hearing aid mold from the outside mold data using rapid prototyping such as stereo lithography with epoxy resin.

15. The method of claim 1 further comprising:
mounting the negative hearing aid mold on a faceplate; and
placing a soft solid in the negative hearing aid mold.

16. The method of claim 15 further comprising installing hearing aid electronics and transducers on the face plate before the negative hearing aid mold is mounted on the faceplate.

17. The method of claim 15 with placing the soft solid in the negative hearing aid mold comprising placing silicone in the negative hearing aid mold.

18. The method of claim 1 further comprising installing hearing aid transducers and electronics in the negative hearing aid mold.

19. The method of claim 1 with processing the auditory canal dimension measurement data comprising processing with a computer processor the auditory canal dimension measurement data representing dimensions of the auditory canal to generate the outside auditory canal dimension data.

20. The method of claim 1 with processing the outside auditory canal dimension data comprises processing with a computer processor the outside auditory canal dimension data to generate outside mold data.

21. Method of claim 1 further comprising measuring auditory canal dimension measurement data representing dimensions of an auditory canal directly from the auditory canal to generate outside auditory canal dimension data that represents outside dimensions of the auditory canal.

22. Method of claim 1 with creating a negative hearing aid mold from the outside mold data using rapid prototyping further comprises creating the negative hearing aid mold from the outside mold data using rapid prototyping such as stereo lithography.

23. Method of claim 1 with creating a negative hearing aid mold from the outside mold data using rapid prototyping further comprises creating the negative hearing aid mold from the outside mold data using fused deposition modeling.

24. Method of claim 1 with creating a negative hearing aid mold from the outside mold data using rapid prototyping further comprises creating the negative hearing aid mold from the outside mold data using Digital light processing.

25. Method of claim 1 with creating a negative hearing aid mold from the outside mold data using rapid prototyping further comprises creating the negative hearing aid mold from the outside mold data using laser sintering.

26. A method for making a negative hearing aid mold comprising the steps of:
processing laser measured auditory canal dimension measurement data representing dimensions of an auditory canal to generate outside auditory canal dimension data that represents outside dimensions of the auditory canal, with the laser measured auditory canal dimension measurement data obtained with a laser measurement system;
processing the outside auditory canal dimension data to generate outside mold data; and
creating a negative hearing aid mold from the outside mold data using rapid prototyping, with the negative hearing aid mold having an inside surface, with the inside surface representing the outside dimensions of the auditory canal from the outside mold data, with the negative hearing aid mold suitable for receipt of a soft solid.
